(19) United States
(12) Patent Application Publication
(10) Pub. No.: US 2015/0232739 A1
(43) Pub. Date: Aug. 20, 2015

(54) CARBOXYLATED CELLULOSE POLYMERS FOR USE IN HYDRAULIC FRACTURING OPERATIONS

(71) Applicant: Nabors Completion & Production Services Co., Houston, TX (US)

(72) Inventors: Matthew BLAUCH, Columbia, MO (US); Daniel ECTOR, Denver, CO (US); Michael GUILLOTTE, Katy, TX (US); James DEMENT, Commerce City, CO (US)

(21) Appl. No.: 14/622,362

(22) Filed: Feb. 13, 2015

Related U.S. Application Data
(60) Provisional application No. 61/940,113, filed on Feb. 14, 2014.

(51) Int. Cl. C09K 8/68; E21B 43/26

(52) U.S. Cl. CPC C09K 8/685; E21B 43/26

(57) ABSTRACT

A low residue fracturing fluid comprises water, an acidified carboxylated gelling agent in an amount in the range of from about 0.06% to about 0.48% by weight. The fracturing fluid can further include a stabilizer agent, a cross-linker, and a buffer.

### CROSS REFERENCE TO RELATED APPLICATION(S)

This application claims priority under 35 U.S.C. §119(e) to U.S. Patent Application No. 61/940,113 entitled “CARBOXYLATED CELLULOSE POLYMERS FOR USE IN HYDRAULIC FRACTURING OPERATIONS,” by Matthew Blauch, Daniel Ector, Michael Guillotte, and James Dement, filed Feb. 14, 2014, which is assigned to the current assignee hereof and incorporated herein by reference in its entirety.

### FIELD OF THE DISCLOSURE

The present invention relates to low residue viscous well treating fluids and methods of using the fluids for treating subterranean zones.

### RELATED ART

The production of oil and natural gas from an underground well (subterranean formation) can be stimulated by a technique called hydraulic fracturing, in which a viscous fluid composition (fracturing fluid) containing a suspended proppant (e.g., sand, bauxite) is introduced into an oil or gas well via a conduit, such as tubing or casing, at a flow rate and a pressure which create, reopen and/or extend a fracture into the oil- or gas-containing formation. The proppant is carried into the fracture by the fluid composition and prevents closure of the formation after pressure is released. Leak-off of the fluid composition into the formation is limited by the fluid viscosity of the composition. Fluid viscosity also permits suspension of the proppant in the composition during the fracturing operation. Cross-linking agents, such as borates, titanates or zirconates are usually incorporated into the composition to control viscosity.

High viscosity aqueous cross-linked gels are used in a variety of operations and treatments carried out in oil and gas wells. Such operations and treatments include, but are not limited to, production stimulation treatments, well completion operations, fluid loss control treatments and treatments to reduce water production.

An example of a production stimulation treatment utilizing a high viscosity cross-linked gelled fluid is hydraulic fracturing. In hydraulic fracturing treatments, the high viscosity fluid is utilized as a fracturing fluid and a carrier fluid for the proppant. That is, the high viscosity fluid is pumped through the well bore into a subterranean zone to be fractured at a rate and pressure such that fractures are formed and extended in the zone. The proppant is suspended in the fracturing fluid so that the proppant is deposited in the fractures. The fracturing fluid is then broken into a thin fluid and returned to the surface. The proppant functions to prevent the fractures from closing whereby conductive channels are formed through which produced fluids can flow to the well bore.

A variety of cross-linking compounds and compositions have heretofore been utilized for cross-linking gelled aqueous well treating fluids. Various sources of borate have been utilized including boric acid, borax, sodium tetraborate, slightly water soluble borates such as ulexite, and other proprietary borate compositions such as polymeric borate compounds. Various compounds that are capable of releasing multivalent metal cations when dissolved in aqueous well treating fluids have also been used heretofore for cross-linking gelled aqueous well treating fluids. Examples of the multivalent metal ions are chromium, zirconium, antimony, titanium, iron, zinc and aluminum.

Delayed cross-linking compositions have also been utilized heretofore such as compositions containing borate ion producing compounds, chelated multivalent metal cations or mixtures of organotitanate compounds and polyhydroxyl containing compounds such as glycerol. However, high viscosity aqueous gels cross-linked with the above described cross-linking agents and compositions have encountered operational problems. That is, the high viscosity cross-linked gelled aqueous well treating fluids have often been difficult to break after being placed in a subterranean zone and upon breaking, leave residue in the subterranean zone, both of which interfere with the flow of produced fluids from the treated zone. Further, at high subterranean zone temperatures in the range of from about 125° F. to about 350° F., a relatively large quantity of gelling agent is required in the cross-linked gelled aqueous well treating fluid to achieve adequate viscosity which produces a greater amount of residue in the treated zone and the high viscosity produced rapidly declines with time.

Thus, there are needs for improved high temperature well treating fluids and methods of using such fluids wherein the fluids require less gelling agent thereby reducing the residue left in subterranean zones treated therewith and the treating fluids have high viscosities which are stable over time at high temperatures.

Accordingly, the industry continues to demand improvements in subterranean drilling operations.

### SUMMARY OF THE INVENTION

In a first aspect, a low residue fracturing fluid comprises water and an acidified carboxylated gelling agent. The acidified carboxylated gelling agent can be present in an amount in the range of from about 0.06% to about 0.48% by weight.

In a second aspect, a method of preparing a low residue fracturing fluid includes hydrating a carboxylated gelling agent. The method further includes adjusting the pH of the hydrated carboxylated gelling agent to less than 6 to form an acidified carboxylated gelling fluid. The method can further include mixing at least one additional agent with the acidified carboxylated gelling fluid. The additional agent can be selected from oxygen scavenger, a cross-linking composition, a gel breaker, or any combination thereof.

In a third aspect, a method of treating a subterranean zone penetrated by a well bore can include preparing a viscous, low residue well treating fluid comprised of water, an acidified carboxylated gelling agent, a cross-linking composition, a oxygen scavenger, and a delayed gel breaker. The method can further include pumping said well treating fluid into said zone by way of said well bore at a rate and pressure sufficient to treat said zone during which said hydrated gelling agent in said treating fluid is cross-linked by said retarded cross-linking composition. The method can further include allowing said viscous treating fluid to break into a thin fluid.

### BRIEF DESCRIPTION OF THE DRAWINGS

Embodiments are illustrated by way of example and are not limited in the accompanying figures.

FIG. 1 includes a comparison graph of a viscosity profile in accordance with an embodiment to the invention.

FIG. 2 includes a second comparison graph of a viscosity profile in accordance with an embodiment to the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the drilling arts.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In a first aspect, a low residue fracturing fluid comprises water and an acidified carboxylated gelling agent. The acidified carboxylated gelling agent can be present in an amount in the range of from about 0.06% to about 0.48% by weight.

The acidified carboxylated gelling agent can include an acidity degree. The degree of acidity as discussed herein represents the percentage of protonated carboxy groups in the carboxylated gelling agent. The degree of acidity can be determined using the Henderson-Hasselbach equation:

$$pH = {pK}_{a} + {log}_{10} ( \frac{[ {A}^{-} ]}{[ HA ]} )$$

Here, pKₐ is the negative logarithmic measure of the aqueous dissociation constant Kₐ of the carboxylated gelling agent (pKₐ=−log₁₀ Kₐ). [HA] is the moles of protonated carboxy groups and [A⁻] is the moles of unprotonated carboxy groups in the gelling agent.

The acidity degree or degree of acidity (DA) is the moles of protonated carboxy groups [HA] over the total number of carboxy groups in the gelling agent. The total number of carboxy groups is the moles of protonated carboxy groups [HA] plus the number of unprotonated carboxy groups [A⁻]. It follows:

$$DA = \frac{[ HA ]}{( [ HA ] + [ {A}^{-} ] )} \qquad ( I )$$

Solving Henderson-Hasselbach for the moles of unprotonated carboxy groups [A⁻]:

[A⁻]=[HA]*10^{pH-pKa} (II)

Combining equation II with equation I:

$$DA = \frac{[ HA ]}{( [ HA ] + [ HA ] * {10}^{p H - p {K}_{a}} )} \\ ∴ DA = \frac{1}{( 1 + {10}^{p H - p {K}_{a}} )}$$

Accordingly, by adjusting the pH of the gelling agent fluid and knowing the pKₐ of the carboxylated gelling agent, one can adjust the degree of acidity. For example, if the pH is adjusted to the pKₐ, i.e. pH=pKₐ then DA=1/(1+10⁰)=½=50%. Likewise, if the pH is one unit below the pKₐ, i.e. pH−pKₐ=−1, then DA=1/(1+10⁻¹)=1/1.1=90.9%. Conversely, if the pH is one unit above the pK_{a′} i.e. pH−pKₐ=1, then DA=1/(1+10¹)=9.1%.

By the same logic, adjusting the pH two units above or below the pKₐ, i.e., pH−pKₐ=±2 one can achieve a DA of 99% or 1%, respectively. It follows that by adjusting the pH within two units of the pKₐ, any DA between 1% and 99% can be generated.

In general, if the gelling agent comprises solely of carboxy groups as acidifying moiety, the pKₐ approximately ranges from 4.0 to 4.8. For very carboxymethyl cellulose, the pKₐ is about 4.3. Accordingly, at pH 4.3, carboxymethyl cellulose is 50% protonated.

In one embodiment, the acidified carboxylated gelling agent can include an acidity degree (DA) of at least 5%, at least 10%, at least 12%, at least 15%, at least 20%, at least 25%, at least 30%, at least 35%, or at least 40%. In another embodiment, the acidified carboxylated gelling agent can include an acidity degree of not greater than 99%, not greater than 95%, not greater than 90%, not greater than 85%, not greater than 80%, not greater than 75%, not greater than 70%, not greater than 65%, not greater than 60%, not greater than 55%, or not greater than 50%. In one embodiment, DA can range from 10% to 50%. In another embodiment, DA can range from 30% to 60%. In yet another embodiment, DA can range from 50% to 90%. In one further embodiment, DA can range from 80% to 99%. Accordingly, the acidified carboxylated gelling agent can include an acidity degree from 10% to 90%, from 40% to 90%, from 50% to 85%, or from 60% to 85%.

It is a feature of this disclosure that the degree of acidity of a gelling agent affects the viscosity profile of the same. Accordingly, the present discovery allows for another tool of manipulating the viscosity of fracturing fluids namely by adjusting or controlling the pH of the fluid. Secondarily, the viscosity profile of fracturing fluids can also be adjusted by controlling the pKₐ of the gelling agent. The pKₐ of the gelling agent is primarily a function of the type of acidic moieties grafted to the gelling agent polymeric units. Acidic groups can include carboxy groups, ammonium groups, sulfonate groups, phosphonate groups, and a combination thereof. Accordingly, the resulting pKₐ depends on numbers and types of such groups in the polymer of the gelling agent. The pKₐ can also be affected by secondary groups such as alkylene groups attached to the acidic groups. For example, the polymer can include carboxymethyl groups (—CH₂—COOH), carboxyethyl groups (—CH₂CH₂—COOH), carboxypropyl groups (—CH₂CH₂CH₂—COOH), and halogenated derivatives thereof, such as fluorinated carboxyalkyl groups, e.g. —CF₂—COOH, —CF₂CF₂—COOH, —CF₂CF₂CF₂—COOH, or mixed forms such as —CH₂CF₂—COOH. In another embodiment, the polymer can include aminomethyl groups (—CH₂—NH₂), aminoethyl groups (—CH₂CH₂—NH₂), aminopropyl groups (—CH₂CH₂CH₂—NH₂), and halogenated derivatives thereof, such as fluorinated carboxyalkyl groups, e.g. —CF₂—NH₂, —CF₂CF₂—NH₂, —CF₂CF₂CF₂—NH₂, or mixed forms such as —CH₂CF₂—NH₂.

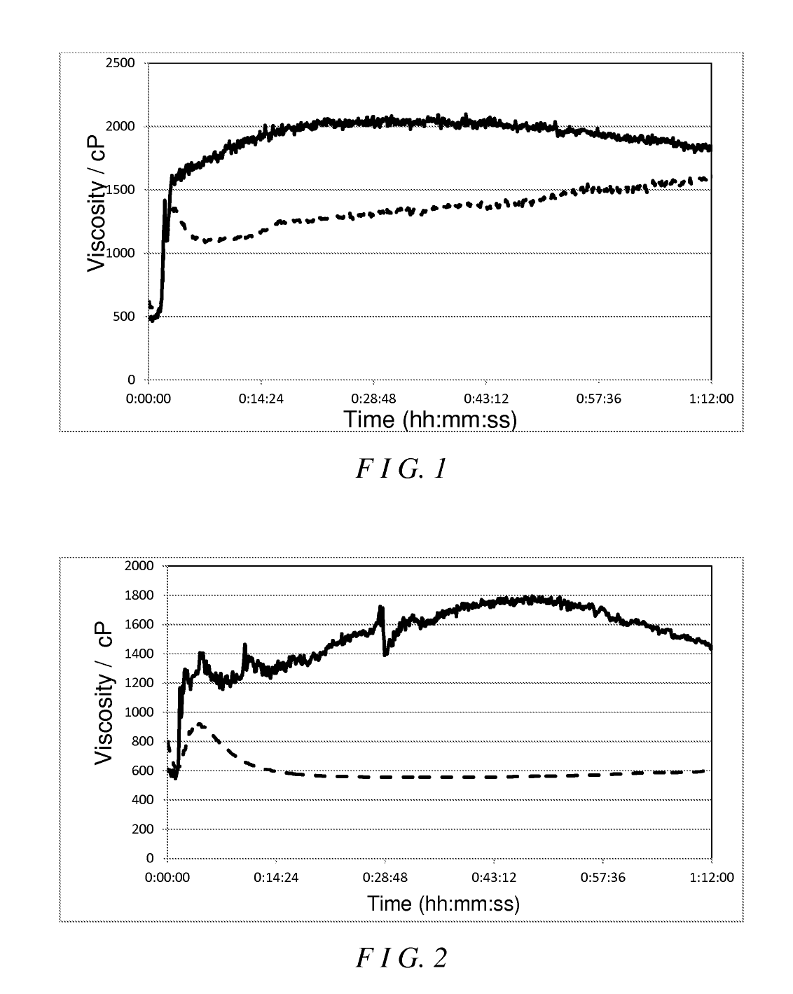

FIG. 1 illustrates the change in the viscosity profile based on the acidification of carboxymethyl cellulose. The details of the fracturing liquids prepared is described in the Experimental section. As can be seen in FIG. 1, the acidified gelling carboxymethyl cellulose (solid line) rises to a viscosity above 2000 cP at approximately 15 minutes and remains within 5% of that viscosity for another 45 minutes. On the other hand, a non-acidified carboxymethyl cellulose increases its viscosity more slowly and fails to reach 2000 cP. It is noted that both fluids contained the same buffer at pH 4.25, stabilizer and cross-linking agent and amounts thereof. The difference between the two lines is that acidified carboxymethly cellulose was maintained at pH 4.25 for about 15 minutes prior to the addition of any other agents.

Thus, in one embodiment, an acidified gelling agent can have a viscosity increase after 20 minutes of gelling time by a factor fᵢ over the non-acidified homolog. The viscosity after 20 minutes is called T₂₀. The T₂₀ as shown in FIG. 1 for the acidified geling agent is about 2000 cP, while the T₂₀ for the non-acidified gelling agent is about 1200 cP. Accordingly, the increase at T₂₀, i.e., fᵢ(T₂₀) is 2000/1200=1.67.

In one embodiment, fᵢ(T₂₀) can be at least 1.1, at least 1.2, at least 1.3, at least 1.4, at least 1.5, at least 1.6, at least 1.7, at least 1.8, or at least 1.9. In another embodiment, fᵢ(T₂₀) can range from 1.1 to 2.0, such as from 1.25 to 1.75. In another embodiment, fᵢ can be greater than 2.

As can be seen in FIG. 2, at about 45 minutes the acidified gelling agent has an fᵢ of about 2.5, i.e. fᵢ(T₄₅)=2.5. Accordingly, in one embodiment, fᵢ(T₄₅) can be at least 2.1, at least 2.2, at least 2.3, at least 2.4, at least 2.5, at least 2.6, at least 2.7, at least 2.8, or at least 2.9. In another embodiment, fᵢ(T₄₅) can range from 1.8 to 3.5, such as from 2.3 to 3.0.

In a second aspect, a method of preparing a low residue fracturing fluid includes hydrating a carboxylated gelling agent. The method further includes adjusting the pH of the hydrated carboxylated gelling agent to less than 6 to form an acidified carboxylated gelling fluid. The method can further include mixing at least one additional agent with the acidified carboxylated gelling fluid. The additional agent can be selected from oxygen scavenger, a cross-linking composition, a gel breaker, or any combination thereof.

The pH can be adjusted to less than 5.5, less than 5, less than 4.5, less than 4, less than 3.8, less than 3.6, less than 3.4, less than 3.2, less than 3, or less than 2.8. In one embodiment, the pH can be at least 2.5, at least 2.7, at least 2.9, at least 3.1, at least 3.3, at least 3.5, at least 3.7, at least 3.9, at least 4.1, at least 4.3, at least 4.5, at least 4.7, or at least 4.9. In one embodiment, the pH can range between 2.5 and 5.5, such as between 2.5 and 5.3, or between 3 and 5.1.

In a third aspect, a method of treating a subterranean zone penetrated by a well bore can include preparing a viscous, low residue well treating fluid comprised of water, an acidified carboxylated gelling agent, a cross-linking composition, a oxygen scavenger, and a delayed gel breaker. The method can further include pumping said well treating fluid into said zone by way of said well bore at a rate and pressure sufficient to treat said zone during which said hydrated gelling agent in said treating fluid is cross-linked by said retarded cross-linking composition. The method can further include allowing said viscous treating fluid to break into a thin fluid.

In one embodiment, the carboxylated gelling agent can be selected from the group consisting of a carboxylated galactomannan, a carboxylated glucomannan, a carboxylated cellulose, and a combination thereof.

In another embodiment, the low residue fracturing fluid can include a non-carboxylated gelling agent. The non-carboxylated gelling agent can be selected from the group consisting of a galactomannan, a glucomannan, a cellulose, and a combination thereof. In one embodiment, the mass ratio of carboxylated gelling agent to a total of carboxylated gelling agent and non-carboxylated gelling agent ranges from 1 wt % to 99 wt %, such as from 10 wt % to 95 wt %, from 20 wt % to 90 wt %, from 30 wt % to 85 wt %, from 40 wt % to 80 wt %, or from 50 wt % to 75 wt %.

In yet one further embodiment, the carboxylated gelling agent is selected from carboxymethyl cellulose, carboxylated hydroxypropyl cellulose, carboxymethyl hydroxyethyl cellulose, carboxymethyl hydroxypropyl cellulose, carboxymethyl guar, carboxylated hydroxypropyl guar, carboxymethyl hydroxyethyl guar, carboxymethyl hydroxypropyl guar, carboxymethyl xanthan, carboxylated hydroxypropyl xanthan, carboxymethyl hydroxyethyl xanthan, carboxymethyl hydroxypropyl xanthan, or any combination thereof.

The low residue fracturing fluid can further include a cross-linking agent. The cross-linking agent includes metal salt. The metal can be selected from boron, aluminum, zirconium, iron, antimony, titanium, or any combination thereof. In one embodiment, the metal comprises zirconium. In another embodiment, the metal consists essentially of zirconium. In another embodiment, the metal salts can include a zirconium(IV) salt. In one particular embodiment, the zirconium(IV) salt can include zirconium oxychloride.

In another embodiment, the low residue fracturing fluid can include a chelating agent. The chelating agent can be selected from a diol, a diamine, a dicarboxylic acid, a carboxylic acid, an alkanol amine, a hydroxycarboxylic acid, an aminocarboxylic acid, or any combination thereof. In a particular embodiment, the chelating agent can be a citrate, a lactate, or an acetate. In another embodiment, the chelating agent can be ethylenediaminetetraacetic acid, ethylene glycol tetraacetic acid, or any combination thereof. In yet one further embodiment, the alkanol amine includes triethanolamine.

In one embodiment, the cross-linking agent can be present in an amount of at least 0.1 gpt (gallons per thousand gallons), such as at least 0.15 gpt, at least 0.2 gpt, at least 0.25 gpt, at least 0.3 gpt, at least 0.4 gpt, or at least 0.5 gpt. In another embodiment, the cross-linking agent can be present in an amount of not greater than 1 gpt (gallons per thousand gallons), such as not greater than 0.9 gpt, not greater than 0.8 gpt, not greater than 0.7 gpt, not greater than 0.6 gpt, not greater than 0.55 gpt.

The gpt concentration is calculated from a stock solution of stock suspension of the cross-linking agent. In embodiments the stock solution or stock suspension includes between 5 wt % to 50 wt % of cross-linking agent, such as from 10 wt % to 30 wt %, and in one particular embodiment 25 wt % of cross-linking agent. For example, to arrive at a fluid comprising 0.15 gpt of cross-linking agent, 0.15 gallons of the stock suspension is added to thousand gallons of the fracturing fluid.

In yet another embodiment, the low residue fracturing fluid further includes an oxygen scavenger. The oxygen scavenger can include a sulfur containing compound. The sulfur containing compound can be selected from thiosulfates, sulfites, bisulfites, or any combination thereof. The oxygen scavenger can be present in an amount of at least 1 wt %, such as at least 1.5 wt %, at least 2 wt %, at least 2.5 wt %, at least 3 wt %, at least 4 wt %, or at least 5 wt %. The oxygen scavenger can be present in an amount of not greater than 10 wt %, such as not greater than 9 wt %, not greater than 8 wt %, not greater than 7 wt %, not greater than 6 wt %, not greater than 5.5 wt %.

In one embodiment, the low residue fracturing fluid can have a peak viscosity at 175 degF of at least 8000 cP per wt % amount of acidified carboxylated gelling agent. Accordingly, if the acidified carboxylated gelling agent is present in an amount of 0.25 wt %, the peak viscosity at 175 degF is 0.25 times 8000, cP i.e., 2000 cP. In another embodiment, the low residue fracturing fluid maintains a viscosity at 220 degF of at least 4000 cP per wt % amount of acidified carboxylated gelling agent for 45 minutes.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

The concepts are better understood in view of the embodiments described below that illustrate and do not limit the scope of the present invention. The embodiments provide a combination of features, which can be combined in various matters to describe and define a method and system of the embodiments. The description is not intended to set forth a hierarchy of features, but different features that can be combined in one or more manners to define the invention. In the foregoing, reference to specific embodiments and the connection of certain components is illustrative. It will be appreciated that reference to components as being coupled or connected is intended to disclose either direct connected between said components or indirect connection through one or more intervening components as will be appreciated to carry out the methods as discussed herein.

As such, the above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The disclosure is submitted with the understanding that it will not be used to interpret or limit the scope or meaning of the claims. In addition, in the foregoing disclosure, various features may be grouped together or described in a single embodiment for the purpose of streamlining the disclosure. This disclosure is not to be interpreted as reflecting an intention that the embodiments herein limit the features provided in the claims, and moreover, any of the features described herein can be combined together to describe the inventive subject matter. Still, inventive subject matter may be directed to less than all features of any of the disclosed embodiments.

### EXPERIMENTALS

The following is the working protocol to prepare the fracturing fluid for viscosity profile determination:

1) 0.53 g of the polymer is weighed on an analytical balance.

2) The polymer is added to 200 ml of water (this equates to a 22 lb gel-22 lbs polymer/1000 gallons water)

3) The polymer solution is “hydrated” (mixed) on a Waring blender at low shear for 15 minutes

4) The pH of the solution is adjusted with an acid to a desired value. The acid selected can be acetic acid, formic acid, hydrochloric acid, citric acid, trifluoroacetic acid. The pH for carboxymethyl cellulosic gelling agents is adjusted to 4.25.

5) A oxygen scavenger is added prior to step 4 when testing effects of non-acidified gelling condition, and after step 4 when testing effects of acidified gelling condition. The oxygen scavenger is sodium thiosulfate and does not affect the pH.

6) A zirconium crosslinker is added in the amount of 1.25 gpt.

7) The solution is allowed to mix for 10 seconds

A volume required for testing is drawn with a syringe and loaded onto a Chandler 5550 High Pressure High Temperature Viscometer. The tests were run for 90 minutes at 175° F.

FIG. 1 depicts a viscosity profile for a fracturing liquid of 22 lb gel of carboxymethylcellulose adjusted to pH 4.25 w/ Formic Acid, 1 gpt sodium thiosulfate stabilizer and 1.25 gpt of a zirconium crosslinker. FIG. 2 depicts a viscosity profile for a fracturing liquid of 22 lb gel of carboxymethylcellulose adjusted to pH 4.25 w/ Formic Acid, and 0.5 gpt sodium thiosulfate stabilizer and 1.25 gpt of a zirconium crosslinker. As can be seen in the graphs, the acidified carboxymethyl cellulose has a higher viscosity profile than those that were stabilized during gelling.

The following is a list of non-limiting items that fall within the scope of the present disclosure:

Item 1. A low residue fracturing fluid comprising:

water;

an acidified carboxylated gelling agent in an amount in the range of from about 0.06% to about 0.48% by weight.

Item 2. The low residue fracturing fluid of item 1, wherein the acidified carboxylated gelling agent includes an acidity degree of at least 5%, such as at least 10%, at least 12%, at least 15%, at least 20%, at least 25%, at least 30%, at least 35%, or at least 40%.

Item 3. The low residue fracturing fluid of item 1, wherein the acidified carboxylated gelling agent includes an acidity degree not greater than 99%, not greater than 95%, not greater than 90%, not greater than 85%, not greater than 80%, not greater than 75%, not greater than 70%, not greater than 65%, not greater than 60%, not greater than 55%, or not greater than 50%.

Item 4. The low residue fracturing fluid of item 1, wherein the acidified carboxylated gelling agent includes an acidity degree from 10% to 90%, from 40% to 90%, from 50% to 85%, or from 60% to 85%.

Item 5. The low residue fracturing fluid of item 1, wherein the carboxylated gelling agent is selected from the group consisting of a carboxylated galactomannan, a carboxylated glucomannan, a carboxylated cellulose, and a combination thereof.

Item 6. The low residue fracturing fluid of item 1, further comprising a non-carboxylated gelling agent.

Item 7. The low residue fracturing fluid of item 6, wherein the non-carboxylated gelling agent is selected from the group consisting of a galactomannan, a glucomannan, a cellulose, and a combination thereof.

Item 8. The low residue fracturing fluid of item 6, wherein a mass ratio of carboxylated gelling agent to a total of carboxylated gelling agent and non-carboxylated gelling agent ranges from 1 wt % to 99 wt %, from 10 wt % to 95 wt %, from 20 wt % to 90 wt %, from 30 wt % to 85 wt %, from 40 wt % to 80 wt %, or from 50 wt % to 75 wt %.

Item 9. The low residue fracturing fluid of item 1, wherein the carboxylated gelling agent is selected from carboxymethyl cellulose, carboxylated hydroxypropyl cellulose, carboxymethyl hydroxyethyl cellulose, carboxymethyl hydroxypropyl cellulose, carboxymethyl guar, carboxylated hydroxypropyl guar, carboxymethyl hydroxyethyl guar, carboxymethyl hydroxypropyl guar, carboxymethyl xanthan, carboxylated hydroxypropyl xanthan, carboxymethyl hydroxyethyl xanthan, carboxymethyl hydroxypropyl xanthan, or any combination thereof.

Item 10. The low residue fracturing fluid of item 1 further comprising a cross-linking agent.

Item 11. The low residue fracturing fluid of item 10, wherein the cross-linking agent includes metal salt.

Item 12. The low residue fracturing fluid of item 11, wherein the metal is selected from boron, aluminum, zirconium, iron, antimony, titanium, or any combination thereof.

Item 13. The low residue fracturing fluid of item 11, wherein the metal comprises zirconium.

Item 14. The low residue fracturing fluid of item 11, wherein the metal consists essentially of zirconium.

Item 15. The low residue fracturing fluid of item 11, wherein the metal salts includes a zirconium(IV) salt.

Item 16. The low residue fracturing fluid of item 15, wherein the zirconium(IV) salt is zirconium oxychloride.

Item 17. The low residue fracturing fluid of item 1, wherein the fracturing fluid includes a chelating agent.

Item 18. The low residue fracturing fluid of item 17, wherein the chelating agent is selected from a diol, a diamine, a dicarboxylic acid, a carboxylic acid, an alkanol amine, a hydroxycarboxylic acid, an aminocarboxylic acid, or any combination thereof.

Item 19. The low residue fracturing fluid of item 17, wherein the chelating agent is a citrate, a lactate, an acetate.

Item 20. The low residue fracturing fluid of item 17, wherein the chelating agent ethylenediaminetetraacetic acid, ethylene glycol tetraacetic acid, or any combination thereof.

Item 21. The low residue fracturing fluid of item 18, wherein the alkanol amine includes triethanolamine.

Item 22. The low residue fracturing fluid of item 10, wherein the cross-linking agent is present in an amount of at least 0.1 gpt (gallons per thousand gallons, i.e., gallons of a stock solution or stock suspension comprising between 5 wt % to 50 wt % of the cross-linking agent per thousand gallons of fracturing fluid), such as at least 0.15 gpt, at least 0.2 gpt, at least 0.25 gpt, at least 0.3 gpt, at least 0.4 gpt, or at least 0.5 gpt.

Item 23. The low residue fracturing fluid of item 10, wherein the cross-linking agent is present in an amount of not greater than 1 gpt (gallons per thousand gallons, i.e., gallons of a stock solution or stock suspension comprising between 5 wt % to 50 wt % of the cross-linking agent per thousand gallons of fracturing fluid), such as not greater than 0.9 gpt, not greater than 0.8 gpt, not greater than 0.7 gpt, not greater than 0.6 gpt, not greater than 0.55 gpt.

Item 24. The low residue fracturing fluid of item 1 further comprising an oxygen scavenger.

Item 25. The low residue fracturing fluid of item 24, wherein the oxygen scavenger includes a sulfur containing compound.

Item 26. The low residue fracturing fluid of item 25, wherein the sulfur containing compound is selected from thiosulfates, sulfites, bisulfites, or any combination thereof.

Item 27. The low residue fracturing fluid of item 10, wherein the cross-linking agent is present in an amount of at least 1 wt %, such as at least 1.5 wt %, at least 2 wt %, at least 2.5 wt %, at least 3 wt %, at least 4 wt %, or at least 5 wt %.

Item 28. The low residue fracturing fluid of item 10, wherein the cross-linking agent is present in an amount of not greater than 10 wt %, such as not greater than 9 wt %, not greater than 8 wt %, not greater than 7 wt %, not greater than 6 wt %, not greater than 5.5 wt %.

Item 29. The low residue fracturing fluid of item 1, wherein the low residue fracturing fluid has a peak viscosity at 175 degF of at least 8000 cP per wt % amount of acidified carboxylated gelling agent.

Item 30. The low residue fracturing fluid of item 1, wherein the low residue fracturing fluid maintains a viscosity at 220 degF of at least 4000 cP per wt % amount of acidified carboxylated gelling agent for 45 minutes.

Item 31. A method of preparing a low residue fracturing fluid, the method comprising:

(a) hydrating a carboxylated gelling agent;

(b) adjusting the pH of the hydrated carboxylated gelling agent to less than 6 to form an acidified carboxylated gelling fluid; and

(c) mixing an oxygen scavenger, a cross-linking composition, a gel breaker, or any combination thereof with the acidified carboxylated gelling fluid.

Item 32. A method of treating a subterranean zone penetrated by a well bore comprising the steps of:

(a) preparing a viscous, low residue well treating fluid comprised of water, an acidified carboxylated gelling agent, a cross-linking composition, a oxygen scavenger, and a delayed gel breaker;

(b) pumping said well treating fluid into said zone by way of said well bore at a rate and pressure sufficient to treat said zone during which said hydrated gelling agent in said treating fluid is cross-linked by said retarded cross-linking composition; and

(c) allowing said viscous treating fluid to break into a thin fluid.

What is claimed is:

1. A low residue fracturing fluid comprising:
water;
an acidified carboxylated gelling agent in an amount in the range of from about 0.06% to about 0.48% by weight.

2. The low residue fracturing fluid of claim 1, wherein the acidified carboxylated gelling agent includes an acidity degree of at least 5%, such as at least 10%, at least 12%, at least 15%, at least 20%, at least 25%, at least 30%, at least 35%, or at least 40%.

3. The low residue fracturing fluid of claim 1, wherein the acidified carboxylated gelling agent includes an acidity degree not greater than 99%, not greater than 95%, not greater than 90%, not greater than 85%, not greater than 80%, not greater than 75%, not greater than 70%, not greater than 65%, not greater than 60%, not greater than 55%, or not greater than 50%.

4. The low residue fracturing fluid of claim 1, wherein the acidified carboxylated gelling agent includes an acidity degree from 10% to 90%, from 40% to 90%, from 50% to 85%, or from 60% to 85%.

5. The low residue fracturing fluid of claim 1, wherein the carboxylated gelling agent is selected from the group consisting of a carboxylated galactomannan, a carboxylated glucomannan, a carboxylated cellulose, and a combination thereof.

6. The low residue fracturing fluid of claim 1, further comprising a non-carboxylated gelling agent.

7. The low residue fracturing fluid of claim 6, wherein the non-carboxylated gelling agent is selected from the group consisting of a galactomannan, a glucomannan, a cellulose, and a combination thereof.

8. The low residue fracturing fluid of claim 6, wherein a mass ratio of carboxylated gelling agent to a total of carboxylated gelling agent and non-carboxylated gelling agent ranges from 1 wt % to 99 wt %, from 10 wt % to 95 wt %, from 20 wt % to 90 wt %, from 30 wt % to 85 wt %, from 40 wt % to 80 wt %, or from 50 wt % to 75 wt %.

9. The low residue fracturing fluid of claim 1, wherein the carboxylated gelling agent is selected from carboxymethyl cellulose, carboxylated hydroxypropyl cellulose, carboxymethyl hydroxyethyl cellulose, carboxymethyl hydroxypropyl cellulose, carboxymethyl guar, carboxylated hydroxypropyl guar, carboxymethyl hydroxyethyl guar, carboxymethyl hydroxypropyl guar, carboxymethyl xanthan, carboxylated hydroxypropyl xanthan, carboxymethyl hydroxyethyl xanthan, carboxymethyl hydroxypropyl xanthan, or any combination thereof.

10. The low residue fracturing fluid of claim 1 further comprising a cross-linking agent.

11. The low residue fracturing fluid of claim 10, wherein the cross-linking agent includes metal salt.

12. The low residue fracturing fluid of claim 11, wherein the metal is selected from boron, aluminum, zirconium, iron, antimony, titanium, or any combination thereof.

13. The low residue fracturing fluid of claim 1, wherein the fracturing fluid includes a chelating agent.

14. The low residue fracturing fluid of claim 13, wherein the chelating agent is selected from a diol, a diamine, a dicarboxylic acid, a carboxylic acid, an alkanol amine, a hydroxycarboxylic acid, an aminocarboxylic acid, or any combination thereof.

15. The low residue fracturing fluid of claim 10, wherein the cross-linking agent is present in an amount of at least 0.1 gpt, such as at least 0.15 gpt, at least 0.2 gpt, at least 0.25 gpt, at least 0.3 gpt, at least 0.4 gpt, or at least 0.5 gpt.

16. The low residue fracturing fluid of claim 1 further comprising an oxygen scavenger.

17. The low residue fracturing fluid of claim 1, wherein the low residue fracturing fluid has a peak viscosity at 175 degF of at least 8000 cP per wt % amount of acidified carboxylated gelling agent.

18. The low residue fracturing fluid of claim 1, wherein the low residue fracturing fluid maintains a viscosity at 220 degF of at least 4000 cP per wt % amount of acidified carboxylated gelling agent for 45 minutes.

19. A method of preparing a low residue fracturing fluid, the method comprising:
(a) hydrating a carboxylated gelling agent;
(b) adjusting the pH of the hydrated carboxylated gelling agent to less than 6 to form an acidified carboxylated gelling fluid; and
(c) mixing an oxygen scavenger, a cross-linking composition, a gel breaker, or any combination thereof with the acidified carboxylated gelling fluid.

20. A method of treating a subterranean zone penetrated by a well bore comprising the steps of:
(a) preparing a viscous, low residue well treating fluid comprised of water, an acidified carboxylated gelling agent, a cross-linking composition, a oxygen scavenger, and a delayed gel breaker;
(b) pumping said well treating fluid into said zone by way of said well bore at a rate and pressure sufficient to treat said zone during which said hydrated gelling agent in said treating fluid is cross-linked by said retarded cross-linking composition; and
(c) allowing said viscous treating fluid to break into a thin fluid.
